(19) United States
(12) Patent Application Publication
(10) Pub. No.: US 2011/0254310 A1
(43) Pub. Date: Oct. 20, 2011

(54) Device for manipulating a tarpaulin

(76) Inventor: Real Royer, Saint-Hyacinthe (CA)

(21) Appl. No.: 12/662,389

(22) Filed: Apr. 14, 2010

(51) Int. Cl. B60P 7/04

(52) U.S. Cl. 296/100.14

(57) ABSTRACT

A device for manipulating a tarpaulin across a top aperture of a container, the tarpaulin defining a tarpaulin first end section and a substantially opposed tarpaulin second end section, the container defining a bottom wall and a peripheral wall extending substantially upwardly from the bottom wall, the peripheral wall delimiting the top aperture substantially opposed to the bottom wall, the container defining substantially opposed container first and second ends, the tarpaulin first end section being secured to the container substantially adjacent to the container first end. The device includes: at least two arms defining respective substantially opposed arm bottom and top sections, the arm bottom sections being each pivotally coupled to the container through a respective pivot, the pivots being provided at substantially spaced apart locations along the container between the container first and second ends substantially adjacent to the bottom wall, each of the arms being pivotable about the respective pivot between respective arm first and second positions, the arm top section of each of the arms being closer to the container first end in the arm first positions than in the arm second positions; at least two tarpaulin mounting elements each extending from a respective one of the arms substantially adjacent the arm top sections for securing the tarpaulin thereto; at least two biasing element each operatively coupled to a respective one of the arms for biasing independently from each other each of the arms toward the arm first positions; and an actuator for selectively moving the arms between the arm first and second positions.

### FIELD OF THE INVENTION

The present invention relates generally to tarpaulins. More specifically, the present invention is concerned with a device for manipulating a tarpaulin.

### BACKGROUND OF THE INVENTION

Vehicle cargo containers for transporting bulk material such as sawdust, gravel chip, cutter shavings and the like typically include open top boxes such as semi-trailers or the like defining side walls, a front wall, a rear wall and a floor. These open top containers are typically mechanically coupled to various types of vehicles such as cargo ships, railway carts and truck cabins for transporting goods between various locations.

During transportation in these so-called open top containers, there exists a substantial risk that a portion of the load may be blown out of the open top container by various physical phenomena such as vibration, aerodynamically created vacuum, wind or the like. If some of the load is accidentally blown out of the container it may potentially not only cause unnecessary wastage of the transported goods but may also create a dangerous situation.

For example, when the open-top container is attached to a truck cabin, some of the load accidentally blown out of the container may contaminate the road or highway as it whirls around thus causing dangerous ground road conditions. It may also be blown directly towards the windshield of following vehicles creating a potentially disastrous situation.

Accordingly, in many areas, regulations have been implemented for the carriage of various loads, particularly on public highways requiring that open top containers be provided with some type of covering structure for covering the loading aperture during transport. With the increasing number of accidents, these official requirements have become more and more stringent, sometimes requiring adequate coverage for the load on even short journeys.

Consequently, there has been an industry wide move to provide permanently installed flexible covers often referred to as tarpaulins or tarps that can be quickly rolled and unrolled by the driver so as to respectively allow selective uncovering and covering of the load. When these permanently installed tarpaulins are used only occasionally they may be stored on the vehicle in a folded condition and unfolded over the body as and when required.

Various configurations of tarpaulins have been proposed. However, two configurations have proven to be particularly popular. One such configuration is the so called end-rolled tarpaulin which is gathered at one of the longitudinal ends of the container when not in use and moved along the body of the container between operative and stored positions.

The end-rolled tarpaulins are typically gathered at the front end of the vehicle and are usually provided along their length with a number of transverse supporting bars which extend between the two longer side walls of the container. The end-rolled tarpaulins are typically moved by means of a pair of cables trained over pulleys and carrying the tarpaulins with them as they move. With such an arrangement, the movement of the tarpaulin typically moves the bows automatically out of the way so that the latter do not obstruct the re-loading through the top opening. The movement of the bows out of the way also reduces the risks of having the latter damaged by a new load.

The other type of permanently installed tarpaulins preferred by some haulers is commonly referred to as a side-rolled tarpaulin. The side-load tarpaulins, typically, permanently extend the full length of the container body and are rolled and unrolled about a so-called rolling rod that also typically extends the full length of the container body.

Many devices exist for retracting an extending these tarpaulins. However, these devices are typically relatively complex. In addition, they often require that an intended user of the device climb onto the container onto which the tarpaulin retracting and extending device is positioned. This causes risks of injury to the intended user of these devices as the intended user may then fall from the container. In addition, these devices often require that the intended user perform movements in non-ergonomic positions, which may also lead to injuries.

Against this background, there exists a need in the industry to provide a novel device for manipulating a tarpaulin.

An object of the present invention is therefore to provide a device for manipulating a tarpaulin.

### SUMMARY OF THE INVENTION

In a first broad aspect, the invention provides a device for manipulating a tarpaulin across a top aperture of a container, the tarpaulin defining a tarpaulin first end section and a substantially opposed tarpaulin second end section, the container defining a bottom wall and a peripheral wall extending substantially upwardly from the bottom wall, the peripheral wall delimiting the top aperture substantially opposed to the bottom wall, the container defining substantially opposed container first and second ends, the tarpaulin first end section being secured to the container substantially adjacent to the container first end. The device includes: at least two arms each defining respective substantially opposed arm bottom and top sections, the arm bottom sections being each pivotally coupled to the container through a respective pivot, the pivots being provided at substantially spaced apart locations along the container between the container first and second ends substantially adjacent to the bottom wall, each of the arms being pivotable about the respective pivot between respective arm first and second positions, the arm top section of each of the arms being closer to the container first end in the arm first positions than in the arm second positions; at least two tarpaulin mounting elements each extending from a respective one of the arms substantially adjacent the arm top sections, the tarpaulin being securable to the tarpaulin mounting elements; at least two biasing element each operatively coupled to a respective one of the arms for biasing independently from each other each of the arms toward the arm first positions; and an actuator for selectively moving the arms between the arm first and second positions. The tarpaulin is configurable between an extended configuration and a retracted configuration, wherein, in the extended configuration, the arms are in the arm second positions and the tarpaulin substantially covers the top aperture, and in the retracted configuration, the arms are in the arms first positions and the tarpaulin is substantially retracted from the top aperture.

Advantageously, the proposed device is relatively simple to operate using a series of relatively simple, quick and ergonomic steps.

The proposed device is relatively easily manufactured using known techniques and materials. In addition, the proposed device is relatively economical to produce and, in some embodiments of the invention, is retrofittable to existing containers.

In some embodiments of the invention, when the arms are in the second positions, the actuator exerts a force on at least one of the arms directed generally toward the bottom wall. This force helps in maintaining the arms in the arm second position even when external forces, such as aerodynamic forces, are exerted on the arms. The terminology generally downwardly is to be interpreted as having the force exerted by the actuator directed downwardly, as opposed to being directed upwardly. In other words, the vertical component of this force is directed toward the bottom wall.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1, in a perspective view, illustrates a device for manipulating a tarpaulin in accordance with an embodiment of the invention, the device being shown mounted to a container;

FIG. 2, in a side elevation view, illustrates the device shown in FIG. 1 with arms thereof in a second position;

FIG. 3, in a side elevation view, illustrates the device shown in FIGS. 1 and 2 with arms thereof in a position intermediate a first position and the second position;

FIG. 4, in a side elevation view, illustrates the device shown in FIGS. 1 to 3 with arms thereof in the first position;

FIG. 5, in a perspective view, illustrates a drum and a handle usable to rotate the drum, both usable in the device shown in FIGS. 1 to 4;

FIG. 6, in an alternative perspective view, illustrates the drum and the handle shown in FIG. 6;

FIG. 7, in a perspective view, illustrates a drum and a motor usable to rotate the drum, both usable in the device shown in FIGS. 1 to 4;

FIG. 8, in a perspective view, illustrates a biasing element usable in the device shown in FIGS. 1 to 4;

FIG. 9, in a perspective view, illustrates another biasing element usable in the device shown in FIGS. 1 to 4;

FIG. 10, in a perspective view, illustrates yet another biasing element usable in the device shown in FIGS. 1 to 4; and

FIG. 11, in a perspective view, illustrates the device shown in FIGS. 1 to 4 mounted on a truck and used to manipulate a tarpaulin.

### DETAILED DESCRIPTION

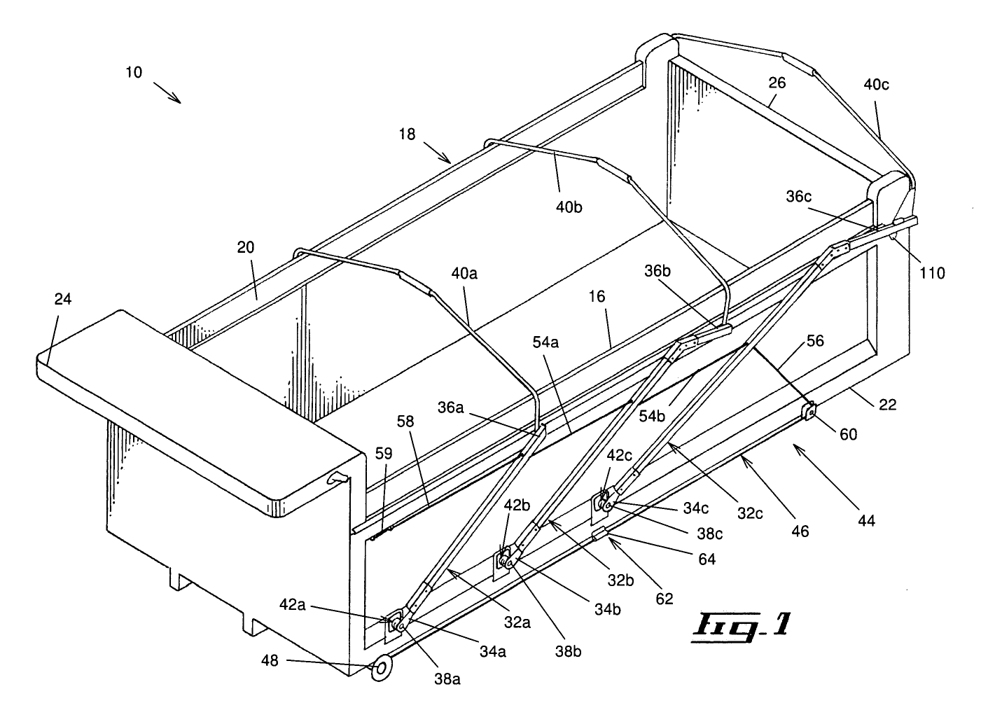

FIG. 1 illustrates a device 10 for manipulating a tarpaulin 12 (seen in FIG. 11) in accordance with an embodiment of the present invention. The device 10 is provided to selectively manipulate the tarpaulin 12 across a top aperture 16 of a container 18. The container 18 defines a bottom wall 22 and a peripheral wall 20 extending substantially upwardly from the bottom wall 22, the top aperture 16 being delimited by the peripheral wall 20 and located substantially opposed to the bottom wall 22. The container 18 defines substantially opposed container first and second ends 24 and 26. Typically, but not exclusively, the container first end 24 is provided at the front end of the container if the container is to be moved by a vehicle. However, in alternative embodiments of the invention, the container 18 is any other suitable container.

As seen in FIG. 11, the tarpaulin 12 defines a tarpaulin first end section 28 and a substantially opposed tarpaulin second end section 30. The tarpaulin first end section 28 is secured to the container 18 substantially adjacent to the container first end 24. For the purpose of this specification, the term tarpaulin should be understood to include tarpaulins per se, canvas, webs and any other suitable fabric that has a capability of retaining at least in part particles, liquids, gases, or any combination thereof, in the container 18.

The reader skilled in the art will readily appreciate that directional designations such as up, down, front, rear and side used in the present document are used only for clarity purposes and refer to the orientation of the device 10 and the container 18 in a typical use. However, the device 10 may be used with containers 18 having any other suitable orientation.

The tarpaulin 12 is configurable between an extended configuration and a retracted configuration. In the extended configuration, the tarpaulin 12 substantially covers the top aperture 16. In FIG. 11, the tarpaulin 12 is shown in the extended configuration. In the retracted configuration (not shown in the drawings), the tarpaulin 12 is substantially retracted from the top aperture 16.

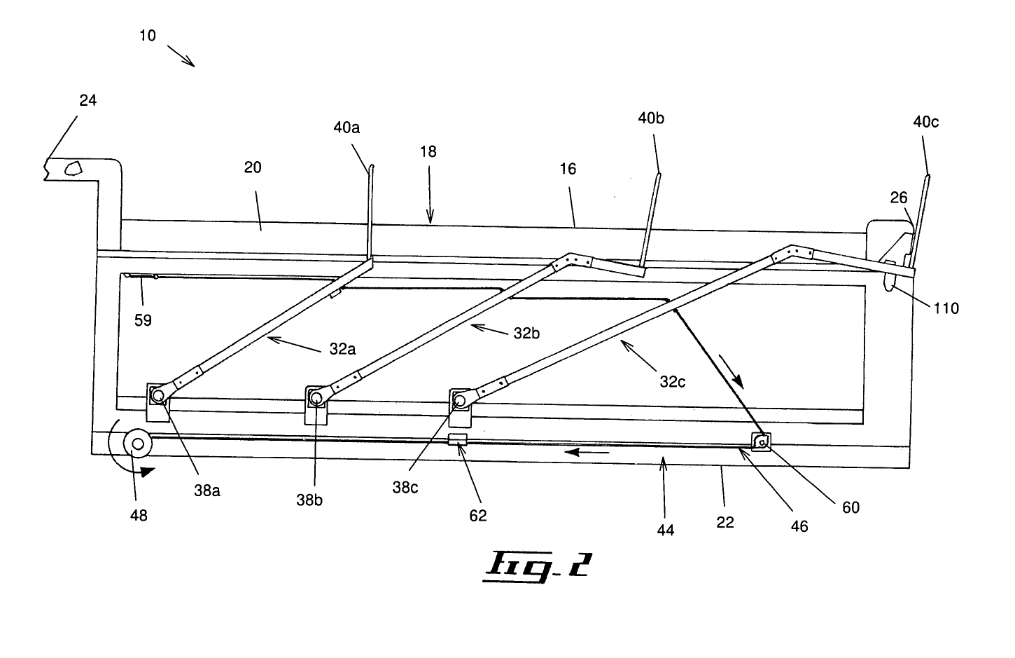

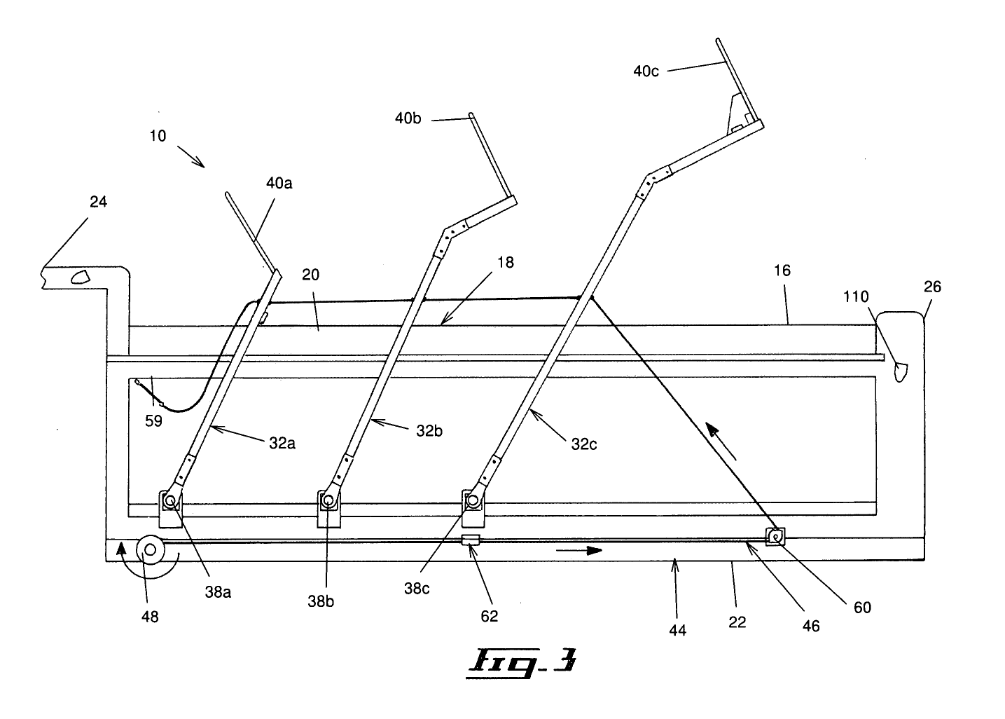

The device 10 includes three arms 32a, 32b and 32c. However, the device 10 can include any number of arms. Typically, the number of arms is 2 or more. Returning to FIG. 1, each of the arms 32a, 32b and 32c defines respective substantially opposed arm bottom sections 34a, 34b and 34c and arm top sections 36a, 36b and 36c. The arm bottom sections 34a, 34b and 34c are each pivotally coupled to the container 18 through a respective pivot 38a, 38b and 38c. The pivots 38a, 38b and 38c are provided at substantially spaced apart locations along the container 18 between the container first and second ends 24 and 26 substantially adjacent to the bottom wall 22. Each of the arms 32a, 32b and 32c is pivotable about its respective pivot 38a, 38b and 38c between respective arm first positions, as seen for example in FIG. 4, and respective arm second positions, as seen for example in FIG. 2. FIG. 3 illustrates the arms 32a, 32b and 32c at a position intermediate the arm first and second positions. The arm top section 36a, 36b and 36c of each of the arms 32a, 32b and 32c is closer to the container first end 24 in the arm first position than in the arm second position.

A tarpaulin mounting element 40a, 40b and 40c extends from each one of the arms 32a, 32b and 32c substantially adjacent the arm top sections 36a, 36b and 36c, the tarpaulin 12 being securable to the tarpaulin mounting elements 40a, 40b and 40c. Also, although not shown in the drawings, each of the arms 32a, 32b and 32c is typically paired with a laterally opposed arm located laterally opposed to the arms 32a, 32b and 32c with respect to the container 18. The laterally opposed arms move jointly pairwise and the tarpaulin mounting elements 40a, 40b and 40c extend between the arms 32a, 32b and 32c and their laterally opposed arms. For example, the tarpaulin mounting elements 40a, 40b and 40c are substantially inverted U-shaped and arc over the container 18.

Biasing elements 42a, 42b and 42c are each operatively coupled to a respective one of the arms 32a, 32b and 32c for biasing independently from each other each of the arms 32a, 32b and 32c toward the arm first positions. Also, an actuator 44 is provided for selectively moving the arms 32a, 32b and 32c between the arm first and second positions. Typically, when the arms are in the arm second positions, the actuator 44 exerts a force on at least one of the arms directed generally toward the bottom wall 22. In the embodiment of the invention shown in the drawings, this is the case for arm 32c.

The tarpaulin 12 is configurable between an extended configuration and a retracted configuration. In the extended configuration, the arms 32a, 32b and 32c are in the arm second positions and the tarpaulin 12 substantially covers the top aperture 16. In the retracted configuration, the arms 32a, 32b and 32c are in the arm first positions and the tarpaulin 12 is substantially retracted from the top aperture 16.

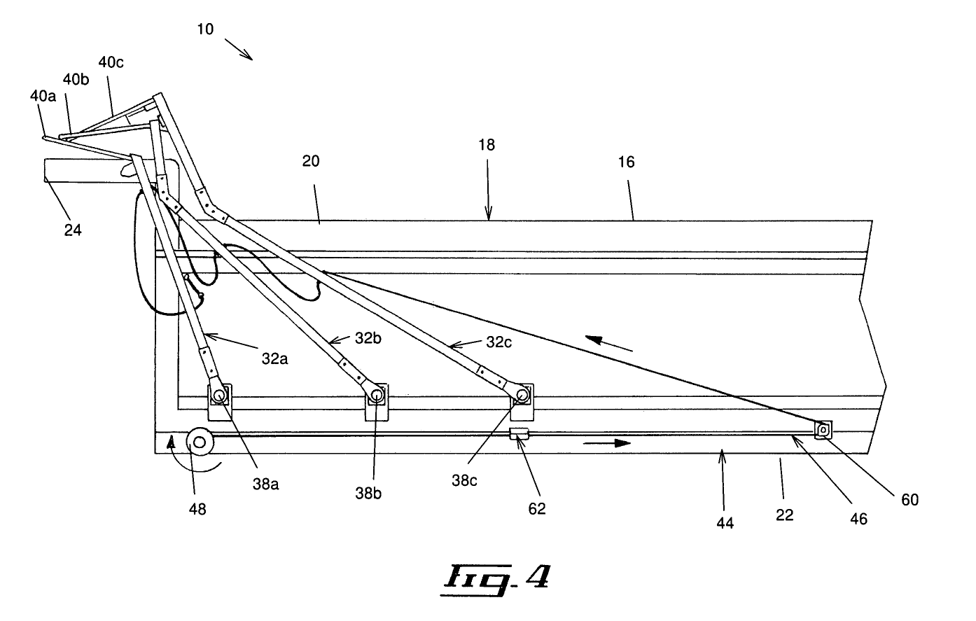

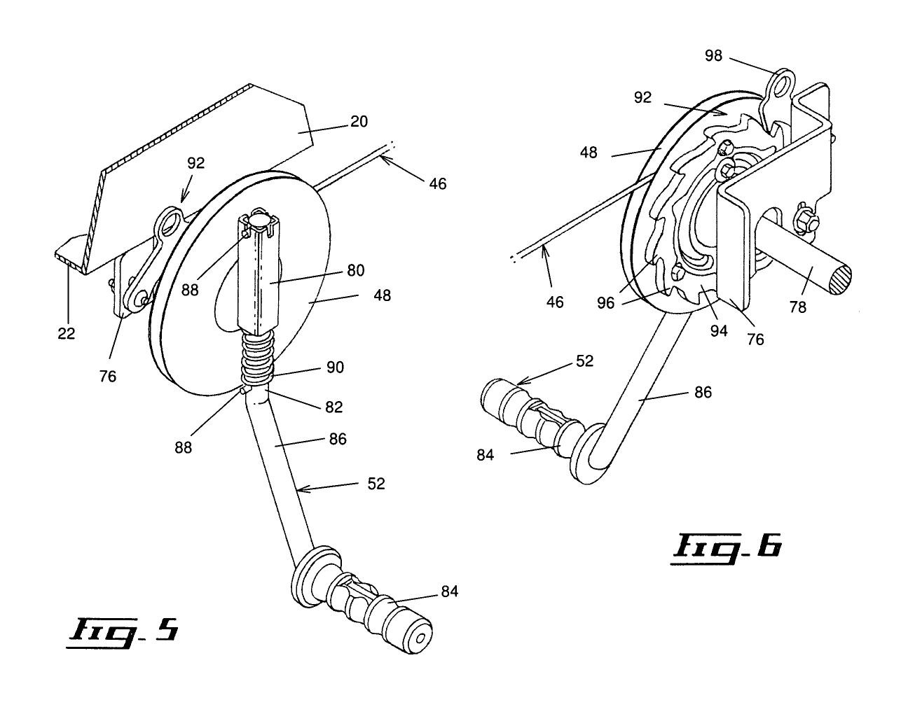

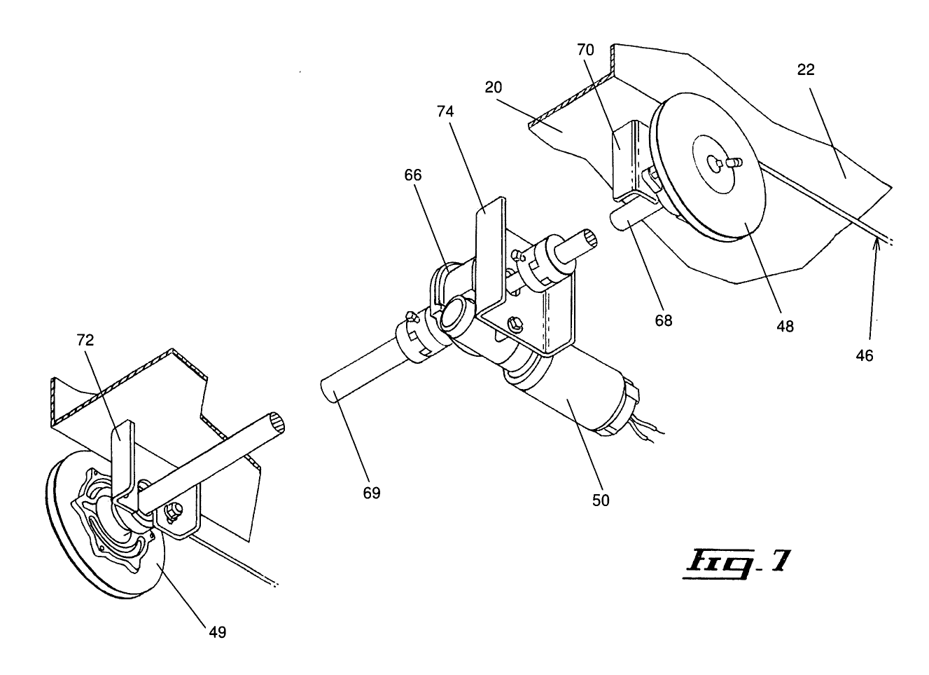

The actuator 44 includes a substantially elongated and substantially flexible actuating element 46 operatively coupled to the arms 32a, 32b and 32c for moving the arms 32a, 32b and 32c between their respective arm first and second positions. The actuator 44 also includes a drum 48 operatively coupled to the actuating element 46 for selectively rolling the actuating element 46 therearound and unrolling the actuating 46 element therefrom. Furthermore, the actuator 44 includes a drum rotating component for rotating the drum 48. For example, the drum rotating component includes a motor 50, as seen in FIG. 7, or a handle 52, as seen in FIGS. 5 and 6.

Returning to FIG. 1, the actuating element 46 typically takes the form of a cable that extends between the arms 32a, 32b and 32c and the drum 48. Typically, the actuating element 46 is attached to the arms 32a, 32b and 32c substantially spaced apart from the pivots 38a, 38b and 38c. In a specific example of implementation, the actuating element 46 is attached to each of the arms 32a, 32b and 32c and defines arm-to-arm coupling sections 54a, 54b between each adjacent pair of the arms 32a, 32b and 32c and an arm-to-drum section 56 extending between the drum 48 and a distalmost arm 32c, the distalmost arm 32c being the arm from the arms 32a, 32b and 32c that is distalmost from the container first end 24. Also, in some embodiments of the invention, the actuating element 46 defines an arm-to-container coupling sections 58 extending between the container 18 and a proximalmost arm 32a, the proximalmost arm 32a being the arm from the arms 32a, 32b and 32c that is proximalmost to the container first end 24. in some embodiments of the invention, a tensioning element 59 is inserted between the arm-to-container coupling section 58 and the container 18 for adjusting a tension of the actuating element 46. Such tensioning elements 59 for example include a turnbuckle and are well-known in the art. Therefore, the tensioning element 59 will not be described in further details.

In some embodiments of the invention, the drum 48 is provided substantially adjacent to the container first end 24, typically substantially adjacent to the bottom wall 22, and the actuator includes a pulley 60 provided substantially adjacent to the bottom wall 22 between the pivots 38a, 38b and 38c and the container second end 26. The arm-to-drum section 56 is bent around the pulley 60. This configuration exerts a generally downwardly directed force on the distalmost arm 32c that facilitates substantial sealing of the top aperture 16 by the tarpaulin 12.

In some embodiments of the invention, the actuator 44 includes a guide 62 provided between the drum 48 and the pulley 60 for guiding the actuating element 46. For example, the guide 62 includes a sleeve 64 for receiving the actuating element 46 therethrough and allowing substantially free longitudinal movements of the actuating element 46 with respect to the sleeve 64.

Referring to FIG. 7, in some embodiments of the invention, the actuator 44 includes the motor 50 which is operatively coupled to the drum 48 for rotating the drum 48 so as to selectively wind the actuating element 46 around the drum 48 or unwind the actuating element 46 from the drum 48 when receiving suitable signals and electrical power from a controller (not shown in the drawings). Rotating the drum 48 in opposite directions achieves these two results. In simple embodiments of the invention, the controller simply takes the form of a 3-state switch selectively powering an electrical motor 50 with currents of selected polarities.

When each of the arms 32a, 32b and 32c are paired with a laterally opposed arm, the drum 48 is also paired with a laterally opposed drum 49. A gearbox 66 receives power from the motor 50. A pair of axles 68 and 69, both driven by the gearbox 66, extend between the gearbox 66 and a respective one of the drums 48 and 49. The drums 48 and 49 are mounted to the axles 68 and 69 for joint rotation therewith. In some embodiments of the invention, the gearbox 66 includes gears so that the rotation speed of the axles 68 and 69 differs from the rotation speed of the motor 50. However, in alternative embodiments of the invention, these rotation speeds are all substantially similar.

Mounting brackets 70, 72 and 74 are provided for mounting the axles 68 and 69 and the gearbox 66 to the container 18. Also, although not shown in the drawings, in some embodiments of the invention, a bracket for mounting the motor 50 to the container 18 is provided. In other embodiments, the motor 50 is simply mounted to the gearbox 66.

Referring to FIG. 5, in some embodiments of the invention, instead of the motor 50, the actuator includes the handle 52. The handle 52 is operatively coupled to the drum 48 for rotating the drum 48 so as to selectively wind the actuating element around the drum 48 or unwind the actuating element 46 from the drum 48.

For example, the drum 48 is mounted to a bracket 76, that is itself secured to the container 18, with an axle 78 (shown only in FIG. 6) that allows rotation of the drum 48 with respect to the bracket 76. A sleeve 80 is welded or otherwise secured to the drum 48 substantially opposed to the axle 78. The handle 52 is mounted to the sleeve 80 for allowing rotation of the drum 48 when the handle 52 is moved. To that effect, the handle 52 defines a handle mounting portion 82 at least partially received in the sleeve 80, a handle actuating portion 84 extending substantially parallel to the axle 78 in a spaced apart relationship relative to the handle mounting portion 82 and a handle spacing portion 86 extending therebetween. Two pins 88 extend from the handle mounting portion 82 in substantially spaced apart relationships with each other.

The sleeve 80 is provided between the two pins 88. One of the pins 88 interferes with the sleeve 80 for preventing withdrawal of the handle mounting portion 82 from the sleeve 80. A coil spring 90 is provided between the other pin 88 and the sleeve 80 for biasing the first pin 88 toward the sleeve 80.

A seen in FIG. 6, in some embodiments of the invention, the actuator 44 includes a lock 92 for selectively preventing rotation of the drum 48 in a direction leading to unwinding of the actuating element 46 from the drum 48. For example, the lock 92 includes a disk 94 provided with a plurality of ramped teeth 96 oriented so as to prevent unwinding of the actuating element 46 from the drum 48 when a pawl 98 pivotally mounted to the bracket 76 engages the teeth 96. The disk 94 is rotatable jointly with the drum 48. When the pawl 98 is pivoted away from the teeth 96, the drum 48 is free to rotate in both directions. Even when the pawl 98 engages the teeth 96, the ramped shape of the teeth 96 allows rotation of the drum 48 only in the direction leading to winding up of the actuating element 46 therearound.

Returning to FIG. 1, the arms 32a, 32b and 32c can take many shapes. For example, one of the arms, such as arm 32c, is substantially hockey-stick shaped. This configuration increases the reach of the arm 32c towards the container second end 26. Some other shapes for the arms 32a, 32b and 32c include a substantially rectilinear arm, such as arm 32a.

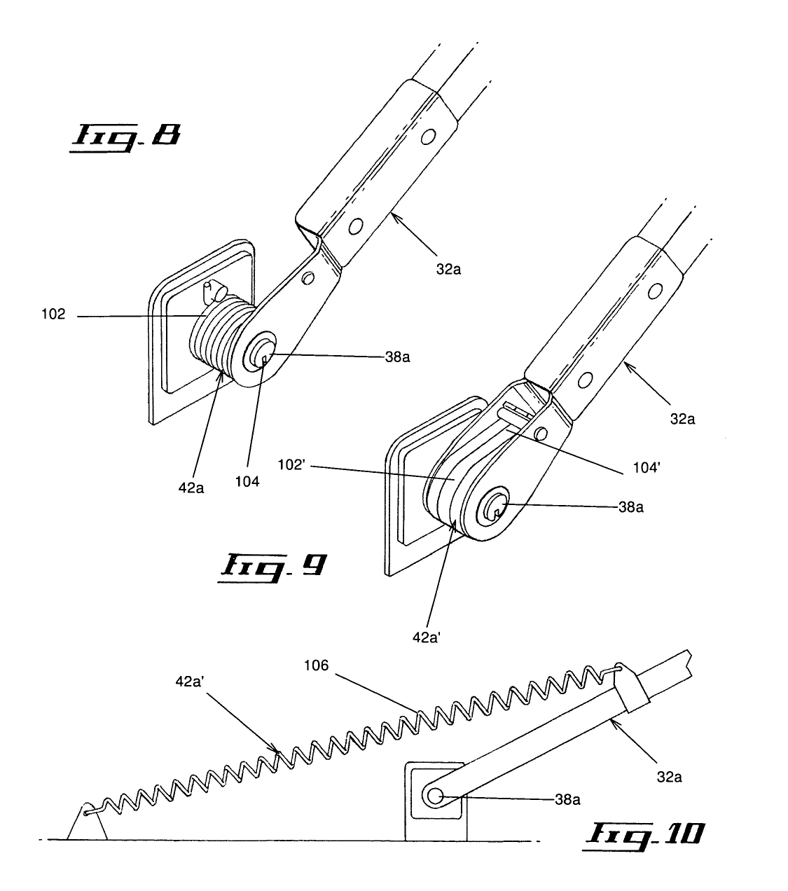

The biasing elements 42a, 42b and 42c can take many forms. FIGS. 8 and 9 illustrate biasing element 42a and 42a′ that are substantially resiliently deformable and define a wound portion 102 and 102′ wound around the pivot 38a and fixed with respect thereto, and an arm engaging portion 104 and 104′ extending therefrom and engaging one the arm 32a to bias the arm 32 toward the first position.

The biasing element 42a shown in FIG. 8 is a coil torsion spring that engages the stationary part of the pivot 38a at one end and the arm 32a at the other end. The biasing element 42a′ shown in FIG. 9 is a flat torsion spring that engages the stationary part of the pivot 38a at one end and the arm 32a at the other end.

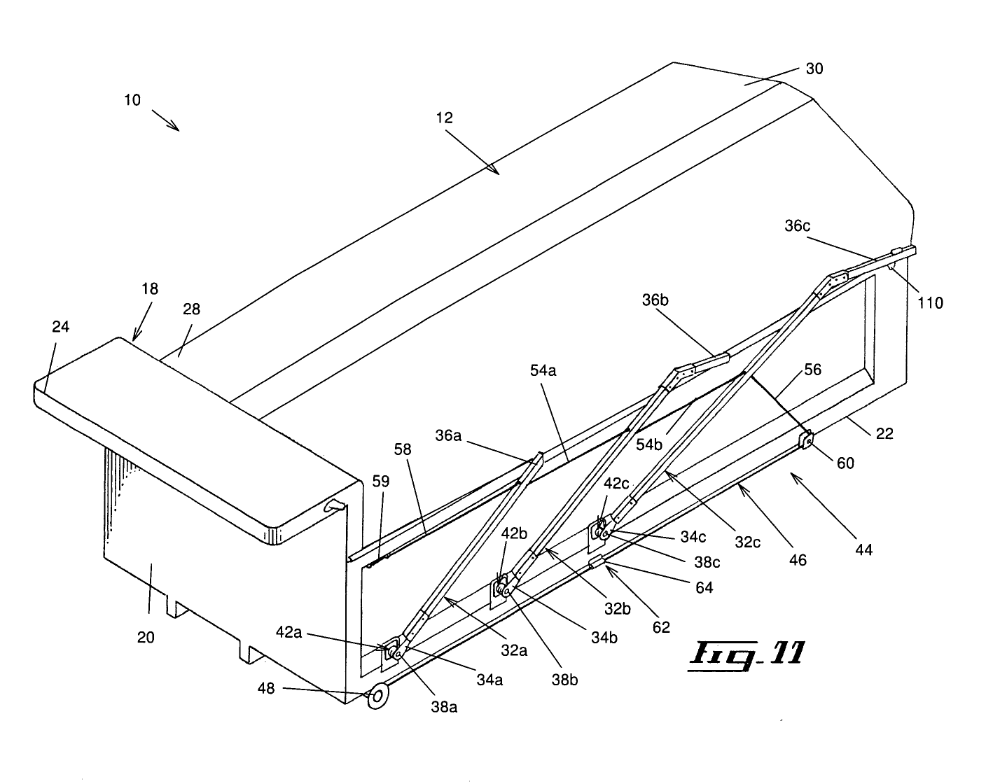

As shown in FIG. 10, in other embodiments of the invention the biasing element 42a″ includes a coil spring 106 extending between the arm 32a and the container 18. Any other suitable configuration of the biasing elements 42a, 42b and 42c is also within the scope of the invention.

As seen in FIG. 1, in some embodiments of the invention, the device 10 includes an abutment member 110 substantially adjacent to the container second end 26 for abutting one of the arms, here arm 32c, thereagainst when the arm 32c is in the second position. The abutment member 110 therefore serves in securing rigidly the arm 32c in the second position due the action of the actuating element 46.

With reference to FIGS. 2 to 4, there is now described the sequence of events occurring in the movement of the arms 32a, 32b and 32c from the second positions to the first positions, which therefore leads to retraction of the device 10 to from the top aperture 16. In FIG. 2, the arms 32a, 32b and 32c are all shown in the second positions. Then, the drum 48 is rotated by the drum rotating element so as to unwind the actuating element 46 therefrom. This action releases gradually the actuating element 46, and therefore allows the biasing elements 42a, 42b and 42c to exert a force on the arms 32a, 32b and 32c leading the movement of the arms 32a, 32b and 32c towards the first positions. As the arms 32a, 32b and 32c move toward their respective first position, the tension in the arm-to-container coupling section 58 and the arm-to-arm coupling sections 54 a and 54b is released, and the arm-to-container coupling section 58 and the arm-to-arm coupling sections 54a and 54b are folded one after the other, as shown in FIGS. 3 and 4, until the arms 32a, 32b and 32c reach the first positions. Deployment of the device 10 across the top aperture 16 proceeds by reversing the above recited actions and winding up the actuating element 46 around the drum 48.

Although the present invention has been described hereinabove by way of preferred embodiments thereof, it can be modified, without departing from the spirit and nature of the subject invention as defined in the appended claims.

What is claimed is:

1. A device for manipulating a tarpaulin across a top aperture of a container, said tarpaulin defining a tarpaulin first end section and a substantially opposed tarpaulin second end section, said container defining a bottom wall and a peripheral wall extending substantially upwardly from said bottom wall, said peripheral wall delimiting said top aperture substantially opposed to said bottom wall, said container defining substantially opposed container first and second ends, said tarpaulin first end section being secured to said container substantially adjacent to said container first end, said device comprising:
at least two arms each defining respective substantially opposed arm bottom and top sections, said arm bottom sections being each pivotally coupled to said container through a respective pivot, said pivots being provided at substantially spaced apart locations along said container between said container first and second ends substantially adjacent to said bottom wall, each of said arms being pivotable about said respective pivot between respective arm first and second positions, said arm top section of each of said arms being closer to said container first end in said arm first positions than in said arm second positions;
at least two tarpaulin mounting elements each extending from a respective one of said arms substantially adjacent said arm top sections, said tarpaulin being securable to said tarpaulin mounting elements;
at least two biasing element each operatively coupled to a respective one of said arms for biasing independently from each other each of said arms toward said arm first positions; and
an actuator for selectively moving said arms between said arm first and second positions;
whereby said tarpaulin is configurable between an extended configuration and a retracted configuration, wherein, in said extended configuration, said arms are in said arm second positions and said tarpaulin substantially covers said top aperture, and in said retracted configuration, said arms are in said arms first positions and said tarpaulin is substantially retracted from said top aperture.

2. A device as defined in claim 1, wherein when said arms are in said second positions, said actuator exerts a force on at least one of said arms directed generally toward said bottom wall.

3. A device as defined in claim 1, wherein said actuator includes a substantially elongated and substantially flexible actuating element operatively coupled to said arms for moving said arms between said respective arm first and second positions.

4. A device as defined in claim 3, wherein said actuating element is attached to said arms substantially spaced apart from said pivots.

5. A device as defined in claim 4, wherein said actuator includes a drum operatively coupled to said actuating element for selectively rolling said actuating element therearound and unrolling said actuating element therefrom.

6. A device as defined in claim 5, wherein said actuating element is attached to each of said arms and defines arm-to-arm coupling sections between each adjacent pair of said arms and an arm-to-drum section extending between said drum and a distalmost arm, said distalmost arm being one of said arms that is distalmost from said container first end.

7. A device as defined in claim 6, wherein said drum is provided substantially adjacent to said container first end and said actuator includes a pulley provided substantially adjacent to said bottom wall between said pivots and said container second end, said arm-to-drum section being bent around said pulley.

8. A device as defined in claim 7, wherein said actuator includes a guide provided between said drum and said pulley for guiding said actuating element.

9. A device as defined in claim 8, wherein said guide includes a sleeve for receiving said actuating element therethrough and allowing substantially free longitudinal movements of said actuating element with respect to said sleeve.

10. A device as defined in claim 6, wherein said actuator includes a motor operatively coupled to said drum for rotating said drum so as to selectively wind said actuating element around said drum or unwind said actuating element from said drum.

11. A device as defined in claim 6, wherein said actuator includes a handle operatively coupled to said drum for rotating said drum so as to selectively wind said actuating element around said drum or unwind said actuating element from said drum.

12. A device as defined in claim 11, wherein said actuator includes a lock for selectively preventing rotation of said drum in a direction leading to unwinding of said actuating element from said drum.

13. A device as defined in claim 1, wherein said biasing elements are substantially resiliently deformable and each defines a wound portion wound around a respective one of said pivots and fixed with respect thereto, and an arm engaging portion extending from said wound portion and engaging a respective one of said arms to bias said respective one of said arms toward said first position.

14. A device as defined in claim 1, wherein said biasing element includes a spring extending between said arm and said container.

15. A device as defined in claim 1, wherein at least one of said arms is substantially hockey-stick shaped.

16. A device as defined in claim 1, further comprising an abutment member substantially adjacent to said container second end for abutting one of said arms thereagainst when said one of said arms is in said second position.
